(19) United States
(12) Patent Application Publication
(10) Pub. No.: US 2010/0235865 A1
(43) Pub. Date: Sep. 16, 2010

(54) Tagging Video Content

(75) Inventors: Connie Jordan, Laguna Niguel, CA (US); Christopher Carmichael, Laguna Niguel, CA (US)

Correspondence Address: Law Office of Scott C Harris Inc, PO Box 1389, Rancho Santa Fe, CA, 92067, US

(73) Assignee: Ubiquity Holdings, San Juan Capistrano, CA (US)

(21) Appl. No.: 12/721,945

(22) Filed: Mar. 11, 2010

Related U.S. Application Data
(60) Provisional application No. 61/159,779, filed on Mar. 12, 2009.

(51) Int. Cl. H04N 5/445; H04M 3/42; G10L 21/00

(52) U.S. Cl. 725/60; 455/414.1; 704/275; 704/E21.001

(57) ABSTRACT

Areas of a video are marked with information about the areas at the marking. For example, an actor's shoes, and other clothing can be marked. That clothing is selected to get more information about the clothing.

This application claims priority from provisional application No. 61/159,779, filed Mar. 12, 2009, the disclosure of which is herewith incorporated by reference.

### BACKGROUND

Videos can be played over various media including over many different kinds of channels. For example, if the video is frequently played over the Internet. When played over the Internet, for example, the video may be decoded and displayed by a cell phone, portable video player, or any other kind of video device such as a conventional television or standalone media player.

### SUMMARY

An embodiment describes tagging items in a video and allowing later watchers of the video to see further information about the tagged items.

Embodiments describe the tagged items representing items in the video, e.g, items of clothing or others, and providing links or other information that allow the user to find more information and/or purchase these clothing items.

### BRIEF DESCRIPTION OF THE DRAWINGS

in the drawings:

FIG. 1 shows a basic block diagram of a video system with tagging;

FIG. 2 shows a flowchart of operation of one of the processors in FIG. 1.

### DETAILED DESCRIPTION

In an embodiment, video is played over a media such as a television channel, a wireless communication channel such as a cell phone, or over the Internet. According to an embodiment, the video is played based on the received video information. The information which is sent over the channel 100 is received in a receiver 110 which can be a television tuner or computer or cell phone, or any other structure that can receive and/or play a video. The receiver 110 outputs a signal 115 that is displayed on the display 120, e.g., a video display or monitor. The receiver 110 may also operate according to a stored program, where that program can be executed by a processor 105 in the receiver. According to another embodiment, the receiver 110 is built into the display, for example similar to a stand-alone television set and its built-in receiver. The information from the channel is displayed on the screen 120. This may be a video of various types including people such as 121; items such as 122, or any any real or simulated item that conventionally are shown in videos or television.

The people in the videos may be models or other celebrities or normal people.

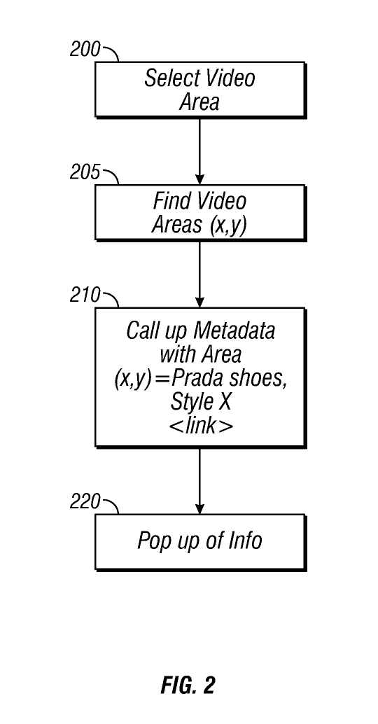

The user interface 130 can control interaction with the video. The user interface can be a trackball that can include a trackball or mouse 131, or any other way of selecting areas on the screen. The user interface 130 can be a conventional remote control, e.g., for control only, or it can include a processor. One of the processors within the system, either the processor 105, or a processor in some other place, may carry out the steps described herein and shown with reference to the flowchart of FIG. 2.

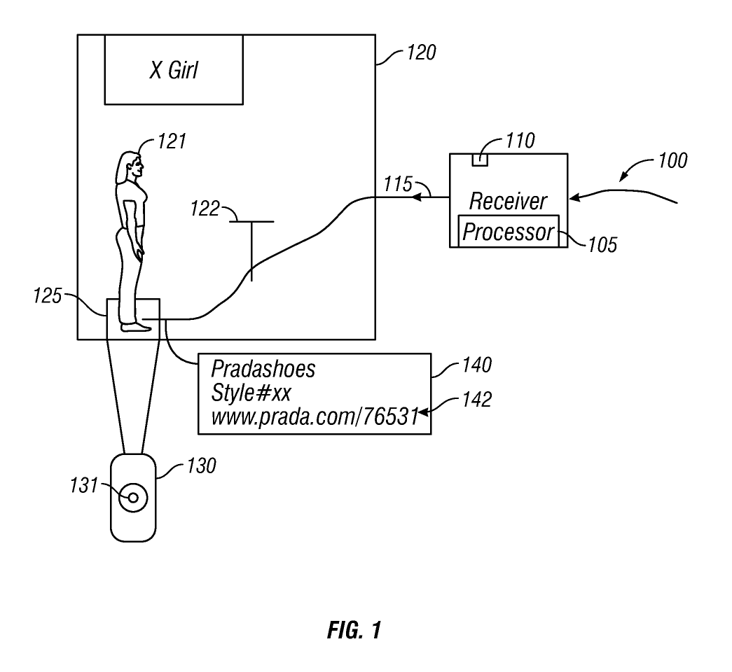

At 200, the user selects an area of the video. The area 125 is selected in FIG. 1, indicating that the user has selected the person's shoes.

At 205, this area is then is used to find video areas, for example different coordinates of areas within the video screen 120. For example, this can be x and y coordinates, or it could represent a number of pixels.

The system has stored in advance different information about different screen areas, e.g., in metadata associated with the video or any other signal that is associated with the video. For example, the person 121 may be wearing various items of clothing such as shirts, skirts, pants, jewelry, glasses, shoes and the like. The metadata accompanying the video has information about those different areas and the different clothing that is in those areas. For example, 210 shows that the area x,y (at the current time t) has information about the clothing that is at the area x,y. In 210, this shoes that clothing as “Prada shoes, style x”. More generally, the style information can be a number, or can be information indicative of a style of the item among a number of styles within the brand name.

There may also be a link, here <link> to the subject of the metadata, e.g., to either the manufacturer's website who makes the clothing, or directly to a reseller of the clothing or item.

Selecting an area x,y which corresponds to a marked area within the metadata causes a pop-up of information at 220. This pop-up of information has information about the specific items that are on the screen. Here, this may pop up with a text box or other information that says “Prada shoes”, and has information about the specific style number of shoes, for example, and a link to a website which includes information such as 142 that represents a link related to the information. The same frame or time of video may also have information about different items at different areas. For example, the area x1, y1 might have information about the pants being worn by the same actor. Different area(s) x2,y2 may have information about different clothing being worn by a different actor, or about an item of non clothing in the frame.

This link can include information from which the origin of the “click” can be obtained, e.g., information can be used to provide information which can be used for paid advertising—for example, pay per click.

Other items such as board shorts, computers, and the like can also be tagged and used in this way. This allows viewers and the users can find out any information about any item on the screen.

The above describes a user interface such as a mouse or remote control being used to select the item 125. The item 125 can be selected in any other way. For example, in one embodiment, the screen 120 may be a touch screen that allows touching areas on the item.

Another item may use voice XML to allow selection of an area on the screen by saying a word corresponding to that item. For example, a user may be able to say the word “shoes” to select the shoes.

In the cell phone, the video may be displayed on the screen, e.g., on a touch screen, or using a mouse or trackball, or using voice xml or voice recognition.

In one embodiment, the video is tagged with content in the video representing the video itself. The video tagging can include information that can be looked up, or information itself that may display a pop-up window shown as 140 in FIG. 1.

Other embodiments are contemplated.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of sending and receiving information can be used. The “metadata” that is used according to the present system can be any stream of information that is associated with the video, e.g., a separate stream of information, or a stream of information that is encoded into the data

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
a video obtaining device which obtains video to be displayed, said video obtaining device producing an output which includes information from said video;
a supplemental video determining device, which accepts an input indicating an area of said video, wherein said supplemental video determining device determines additional information about said area selected by said input at the time that the input indicating the area is received, and where said additional information includes information about an item that is at said area at said time.

2. A system as in claim 1, wherein said item is an item of clothing.

3. A system as in claim 2, wherein said additional information includes a brand name of said item.

4. A system as in claim 3, wherein said additional information includes information indicative of a style of said item among a number of styles within said brand name.

5. A system as in claim 3, wherein said additional information includes an Internet accessible link about said item, said Internet accessible link having information which, when executed, causes a computer to obtain information from an Internet address where said information is about said item at said area and said time.

6. A system as in claim 1, wherein said video supplemental video determining device allows selecting one of a number of different areas on said area of said video, where any of said number of different areas can be selected to get information about a number of different items.

7. A system as in claim 1, wherein said supplemental video determining device accepts information about different clothing items on the person, including first information about a first clothing item on the person and second information about a second clothing item on the second on the same person.

8. A system as in claim 1, wherein said video obtaining device receives video information over a channel.

9. A system as in claim 8, wherein said video information is over received over a wired channel.

10. A system as in claim 8, wherein said video information is received over a wireless channel.

11. A method of interacting with a video, comprising:
displaying a video;
in a computer, accepting selection of either a first area or a second area within the video at a first time;
said computer being programmed to, responsive to accepting selection of the first area, provide first information to the user by a display which shows information about clothing in the first area the first time; and
said computer being programmed to, responsive to accepting selection of the second area, showing second information about second clothing in the second area at the first time, where the information about the first clothing is different from the information about the second clothing.

12. A method as in claim 11, wherein said information includes a hyperlink to a website that has first information about said first clothing, and said second information includes a second hyperlink that has second information about said second clothing.

13. A method as in claim 11, wherein said first clothing is clothing worn on the body, and said second clothing includes shoes.

14. A method as in claim 11, further comprising receiving information indicative of the video over a channel.

15. A cellular phone system that displays video, comprising:
a cell phone transceiver that allows making cellular phone calls, and receiving video information;
a video device which plays video;
a user interface that allows selecting an area of said video while playing;
a processor that determines additional information about said area selected by said input at the time that the input indicating the area is received, and where said additional information includes information about an item that is at said area at said time.

16. A system as in claim 15, wherein said item is an item of clothing.

17. A system as in claim 15, wherein said additional information includes an Internet accessible link about said item, said Internet accessible link having information which is selected on said cellular phone, and obtains information from an Internet address where said information is about said item at said area and said time.

18. A system as in claim 15, wherein said user interface allows selecting one of a number of different areas on said area of said video, where any of said number of different areas can be selected to get information about a number of different items.

19. A system as in claim 15, wherein said supplemental video determining device accepts information about different clothing items on a person, including first information about a first clothing item on the person and second information about a second clothing item on the second on the same person.

20. A system as in claim 15, wherein said user interface accepts voice commands.
